(19) United States
(12) Patent Application Publication
(10) Pub. No.: US 2023/0065576 A1
(43) Pub. Date: Mar. 2, 2023

(54) BATTLE SETTLEMENT INTERFACE DISPLAY METHOD, APPARATUS, DEVICE, AND STORAGE MEDIUM

(71) Applicant: Tencent Technology (Shenzhen) Company Limited, Shenzhen (CN)

(72) Inventor: Yue LIU, Shenzhen (CN)

(21) Appl. No.: 17/982,429

(22) Filed: Nov. 7, 2022

Related U.S. Application Data
(63) Continuation of application No. PCT/CN2022/073424, filed on Jan. 24, 2022.

(30) Foreign Application Priority Data
Mar. 18, 2021 (CN) 202110293056.0

(51) Int. Cl. A63F 13/533; A63F 13/56

(52) U.S. Cl. CPC A63F 13/533; A63F 13/56

(57) ABSTRACT

This application discloses a battle settlement interface display method performed by a computer device. The method includes: displaying a battle settlement interface of a game battle, the battle settlement interface including displaying battle settlement information of at least two user accounts participating in the game battle, the at least two user accounts including a first user account and a second user account, a first model corresponding to the first user account being displayed in a model display region of the battle settlement interface, and the first model being a virtual character model corresponding to the first user account; receiving a trigger operation of selecting the second user account; and displaying a second model corresponding to the second user account in the model display region of the battle settlement interface in replacement of the first model corresponding to the first user account, the second model being a virtual character model corresponding to the second user account.

### CROSS-REFERENCE TO RELATED APPLICATIONS

This application is a continuation application of PCT Patent Application No. PCT/CN2022/073424, entitled “GAME SETTLEMENT INTERFACE DISPLAY METHOD AND APPARATUS, DEVICE AND MEDIUM” filed on Jan. 24, 2022, which claims priority to Chinese Patent Application No. 202110293056.0, filed with the State Intellectual Property Office of the People's Republic of China on Mar. 18, 2021, and entitled “BATTLE SETTLEMENT INTERFACE DISPLAY METHOD, APPARATUS, DEVICE, AND STORAGE MEDIUM”, all of which are incorporated herein by reference in their entirety.

### FIELD OF THE TECHNOLOGY

Embodiments of this application relate to the field of man-machine interaction, and in particular, to a battle settlement interface display method and apparatus, a device, and a storage medium.

### BACKGROUND OF THE DISCLOSURE

A battle game is a game in which a plurality of user accounts compete in the same scene. In some embodiments, the battle game may be a multiplayer online battle arena (MOBA) game.

In a typical MOBA game, a battle settlement interface is displayed after the game battle is over, and game data of each user account in the battle is displayed in the battle settlement interface. For example, the game data includes at least one of a nickname of a user account, equipment information, kill, death, assist (KDA) data, economic data, a score, and most valuable player (MVP) data.

Due to the relatively large amount of information in the battle settlement interface, the user cannot intuitively know a control character corresponding to the user account being viewed, and the information delivering efficiency is poor.

### SUMMARY

Embodiments of this application provide a battle settlement interface display method and apparatus, a device, and a medium.

A battle settlement interface display method, performed by a terminal, the method including:

displaying a battle settlement interface of a game battle, the battle settlement interface including battle settlement information of at least two user accounts participating in the game battle, the at least two user accounts including a first user account and a second user account, a first model corresponding to the first user account being displayed in a model display region of the battle settlement interface, and the first model being a virtual character model corresponding to the first user account;

receiving a trigger operation of selecting the second user account; and

displaying a second model corresponding to the second user account in the model display region of the battle settlement interface in replacement of the first model corresponding to the first user account, the second model being a virtual character model corresponding to the second user account.

A battle settlement interface display apparatus, including:

a display module, configured to

display a battle settlement interface of a game battle, the battle settlement interface including battle settlement information of at least two user accounts participating in the game battle, the at least two user accounts including a first user account and a second user account, displaying a first model corresponding to the first user account being displayed in a model display region of the battle settlement interface, and the first model being a virtual character model corresponding to the first user account;

an interaction module, configured to receive a trigger operation of selecting the second user account; and

the display module is further configured to display a second model corresponding to the second user account in the model display region of the battle settlement interface in replacement of the first model corresponding to the first user account, the second model being a virtual character model corresponding to the second user account.

A computer device is provided, including one or more processors and memories, the one or more memories storing computer-readable instructions, the computer-readable instructions, when executed by the one or more processors, causing the computer device to perform the battle settlement interface display method described above.

One or more non-transitory computer-readable storage media storing computer-readable instructions, the computer-readable storage media storing the computer-readable instructions, the computer-readable instructions, when executed by one or more processors of a computer device, causing the computer device to implement the battle settlement interface display method described above.

A computer program product or a computer program is provided, the computer program product or the computer program including computer-readable instructions, the computer-readable instructions being stored in a non-transitory computer-readable storage medium. A processor of a computer device reads the computer-readable instructions from the computer-readable storage medium and executes the computer-readable instructions to cause the computer device to perform the battle settlement interface display method described above.

Details of one or more embodiments of this application are provided in the subsequent accompanying drawings and descriptions. Other features, objectives, and advantages of this application become apparent from the specification, the accompanying drawings, and the claims.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a structural block diagram of a computer system according to an exemplary embodiment of this application.

FIG. 2 is a method flowchart of a battle settlement interface display method according to another exemplary embodiment of this application.

FIG. 3 is a schematic diagram of a user interface of a battle settlement interface display method according to another exemplary embodiment of this application.

FIG. 4 is a schematic diagram of a user interface of a battle settlement interface display method according to another exemplary embodiment of this application.

FIG. 5 is a method flowchart of a battle settlement interface display method according to another exemplary embodiment of this application.

FIG. 6 is a method flowchart of a battle settlement interface display method according to another exemplary embodiment of this application.

FIG. 7 is a method flowchart of a battle settlement interface display method according to another exemplary embodiment of this application.

FIG. 8 is a block diagram of an apparatus for a battle settlement interface display apparatus according to another exemplary embodiment of this application.

FIG. 9 is a block diagram of a terminal according to another embodiment of this application.

### DESCRIPTION OF EMBODIMENTS

To make the objectives, technical solutions, and advantages of this application clearer, the following further describes implementations of this application in detail with reference to the accompanying drawings.

First, terms involved in the embodiments of this application are briefly introduced.

A virtual environment is displayed (or provided) by an application program when run on a terminal. The virtual environment may be a simulated world of the real world, or may be a semi-simulated semi-fictional three-dimensional world, or may be an entirely fictional three-dimensional world. The virtual environment may be any one of a two-dimensional virtual environment, a 2.5-dimensional virtual environment, and a three-dimensional virtual environment. In some embodiments, the virtual environment is further used for a virtual environment battle between at least two virtual characters, and there are virtual resources available to the at least two virtual characters in the virtual environment. In some embodiments, the virtual environment includes a lower left corner region and an upper right corner region that are symmetrical. Virtual characters on two opposing sides occupy the regions respectively, and the objective of each side is to destroy a target building/stronghold/base/crystal deep in the opponent's region to win victory.

Virtual character refers to a movable object and an unmovable object in a virtual environment. The movable object may be at least one of a virtual person, a virtual animal, and a cartoon person. The unmovable object may be at least one of a virtual building, a virtual plant, and a virtual terrain. In some embodiments, when the virtual environment is a three-dimensional virtual environment, the virtual characters are three-dimensional virtual models. Each virtual character has a shape and a volume in the three-dimensional virtual environment, and occupies some space in the three-dimensional virtual environment. In some embodiments, the virtual character is a three-dimensional character constructed based on three-dimensional human skeleton technology. The virtual character wears different skins to implement different appearances. In some implementations, the virtual character may also be implemented by using a 2.5-dimensional or 2-dimensional model, which is not limited in this embodiment of this application.

Multiplayer online battle arena (MOBA) refers to that in a virtual environment, different virtual teams on at least two enemy camps occupy respective map regions, and compete with a specific victory condition as a goal. The victory condition includes but is not limited to: at least one of occupying a stronghold or destroying a stronghold of an enemy camp, killing a virtual character of the enemy camp, ensuring one's own survival in a specified scene and within a specified moment, grabbing a specific resource, and exceeding a score of the enemy camp within a specified moment. The battle arena game may take place in rounds. The same map or different maps may be used in different rounds of the battle arena game. Each virtual team includes one or more virtual characters, for example, one virtual character, two virtual characters, three virtual characters, or five virtual characters.

A MOBA game is a game in which several bases are provided in a virtual environment, and users on different sides control virtual characters to battle in the virtual environment, occupy bases or destroy the base of the enemy camp. For example, in the MOBA game, the users may be divided into two enemy camps. The virtual characters controlled by the users are scattered in the virtual environment to compete with each other, and the victory condition is to destroy or occupy all enemy bases. The MOBA game uses round as a unit. A duration of a round of the MOBA game is from a time point at which the game starts to a time point at which the victory condition is met.

A user interface (UI) control is a control or an element that is visible or invisible on a user interface of an application, such as a picture, an input box, a text box, a button, a label, or the like. For example, when the UI control is an invisible control, the user may trigger these invisible controls by triggering a specified region in the user interface. Some UI controls respond to an operation performed by the user, for example, a skill control, which controls a master virtual character to release a skill. The user triggers the skill control, and controls the master virtual character to release a skill. The UI control involved in this embodiment of this application includes, but is not limited to: a skill control, a movement control, and a camera movement control.

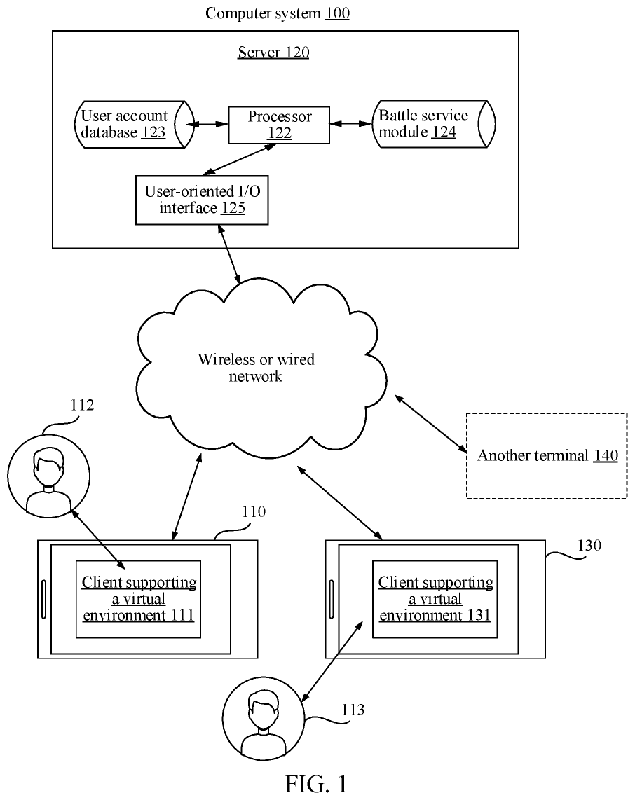

FIG. 1 is a structural block diagram of a computer system according to an exemplary embodiment of this application. The computer system 100 includes: a first terminal 110, a server 120, and a second terminal 130.

A client 111 supporting a virtual environment is installed and run on the first terminal 110, and the client 111 may be a multiplayer online battle program. When the first terminal runs the client 111, a user interface of the client 111 is displayed on a screen of the first terminal 110. The client may be any one of a battle royale shooting game, a virtual reality (VR) application, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG). In this embodiment, an example in which the client is a MOBA game is used for description. The first terminal 110 is a terminal used by a first user 112. In a game battle, the first user 112 uses the first terminal 110 to control a first control character located in the virtual environment to perform activities, and the first control character may be referred to as a master virtual character of the first user 112 in the game battle. The activities of the first control character include, but are not limited to, at least one of adjusting body postures, crawling, walking, running, flying, riding, jumping, driving, picking, shooting, attacking, and throwing. Outside the game battle, the first user 112 uses the first terminal 110 to play a first playing character to perform activities outside the game battle, such as joining a team and a guild, adding a friend, purchasing a prop, purchasing a control character, completing a task, transmitting an email, or the like.

A client 131 supporting a virtual environment is installed and run on the second terminal 130, and the client 131 may be a multiplayer online battle program. When the second terminal 130 runs the client 131, a user interface of the client 131 is displayed on a screen of the second terminal 130. The client may be any one of a battle royale shooting game, a VR application, an AR program, a three-dimensional map program, a virtual reality game, an augmented reality game, an FPS, a TPS, a MOBA, and an SLG. In this embodiment, an example in which the client is a MOBA game is used for description. The second terminal 130 is a terminal used by a second user 113. In a game battle, the second user 113 uses the second terminal 130 to control a second control character located in the virtual environment to perform activities, and the second control character may be referred to as a master virtual character of the second user 113 in the game battle. Outside the game battle, the second user 113 uses the second terminal 130 to play a second playing character to perform activities outside the game battle, such as joining a team and a guild, adding a friend, purchasing a prop, purchasing a control character, completing a task, transmitting an email, or the like.

In some embodiments, in the game battle, the first control character and the second control character are in the same virtual environment. In some embodiments, the first control character and the second control character may belong to the same camp, the same team, the same organization, or may have a temporary communication permission. In some embodiments, the first control character and the second control character may belong to different camps, different teams, different organizations, or may be enemies of each other.

In some embodiments, the client installed on the first terminal 110 is the same as the client installed on the second terminal 130, or the clients installed on the two terminals are the same type of clients of different operating system platforms (Android or iOS). The first terminal 110 may generally refer to one of a plurality of terminals, and the second terminal 130 may generally refer to another one of the plurality of terminals. In this embodiment, only the first terminal 110 and the second terminal 130 are used as an example for description. The first terminal 110 and the second terminal 130 are of the same or different device types, the device type including at least one of a smartphone, a tablet computer, an e-book reader, an MP3 player, an MP4 player, a laptop, and a desktop computer.

FIG. 1 shows only two terminals. However, a plurality of other terminals 140 may access the server 120 in different embodiments. In some embodiments, one or more terminals 140 are terminals corresponding to a developer. A developing and editing platform for the client supporting a virtual environment is installed on the terminal 140. The developer may edit and update the client on the terminal 140, and transmit an updated client installation package to the server 120 by using a wired or wireless network. The first terminal 110 and the second terminal 130 may download the client installation package from the server 120 to update the client.

The first terminal 110, the second terminal 130, and the another terminal 140 are connected to the server 120 through a wireless network or a wired network.

The server 120 includes at least one of one server, a plurality of servers, a cloud computing platform, and a virtualization center. The server 120 is configured to provide a backend service for a client supporting a three-dimensional virtual environment. In some embodiments, the server 120 takes on primary computing work, and the terminals take on secondary computing work; alternatively, the server 120 takes on secondary computing work, and the terminals take on primary computing work; alternatively, collaborative computing is performed by using a distributed computing architecture between the server 120 and the terminals.

In an exemplary example, the server 120 includes a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and another terminal 140, such as an avatar of the user account, a nickname of the user account, a combat power value index of the user account, a service region in which the user account is located; the battle service module 124 is configured to provide a plurality of battle rooms for users to battle, such as 1V1 battle, 3V3 battle, 5V5 battle, or the like; and the user-oriented I/O interface 125 is configured to establish communication exchange data with the first terminal 110 and/or the second terminal 130 by using a wireless network or a wired network.

Specifically, by setting a model display region in a battle settlement interface, the model display region is used for displaying models of user accounts participating in the battle. When the user selects a specific user account to participate in the battle, a virtual character model corresponding to the user account is displayed in the model display region. Because the virtual environment of the game is a three-dimensional virtual environment, what the user usually sees when playing the game is a three-dimensional model of a virtual character. The virtual character model is displayed in the battle settlement interface, so that the user may intuitively associate a currently viewed user account with the virtual character viewed in the virtual environment by observing the virtual character model, thereby improving the information delivering efficiency of directly delivering battle settlement information to the user, balancing the information density of the battle settlement interface, and improving the efficiency of obtaining the battle settlement information by the user.

The battle settlement interface display method provided in this embodiment of this application is described with reference to the foregoing introduction to the virtual environment and the description of the implementation environment, and a description is made by using an example in which an execution entity of the method is a terminal shown in FIG. 1. A client runs on the terminal, and the client running on the terminal is a client of an application. The application is a program supporting the virtual environment.

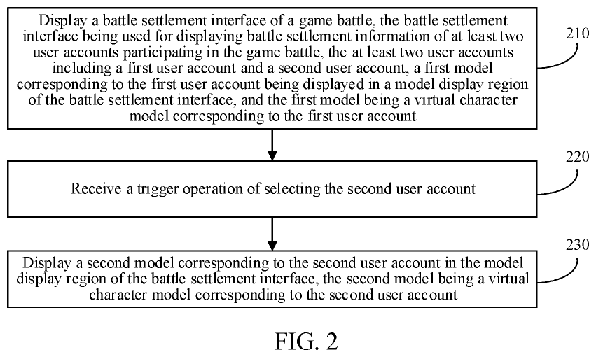

FIG. 2 is a flowchart of a battle settlement interface display method according to an exemplary embodiment of this application. The method may be performed by any terminal in FIG. 1. Specifically, the method may be performed by a client running on the terminal, and the client is a client supporting a virtual environment. The method includes:

step 210. Display a battle settlement interface of a game battle, the battle settlement interface including battle settlement information of at least two user accounts participating in the game battle, the at least two user accounts including a first user account and a second user account, a first model corresponding to the first user account being displayed in a model display region of the battle settlement interface, and the first model being a virtual character model corresponding to the first user account.

A game battle settlement interface is an interface displayed after the game battle is over, and the game battle settlement interface is used for displaying battle settlement information of the battle. The battle settlement information includes: at least one of victory or defeat of a master user account (or a team that the master user account belongs to) in the battle, information data of at least two user accounts participating in the battle in the battle, a friend adding control, a main interface returning control, and a room returning control. The information data of at least two user accounts participating in the battle respectively in the battle includes: at least one of a nickname of the user account, an avatar of the virtual character controlled by the user account in the battle, a score, KAD (also referred to as “kill, death, and assist”), and an MVP.

In this embodiment provided in this application, a model display region is set in the battle settlement interface, and the model display region is used for displaying a three-dimensional virtual model. For example, the model display region is used for displaying at least one virtual character model corresponding to a user account. In an exemplary implementation, the model display region is used for displaying a fixed image of the three-dimensional virtual model, that is, the user may only observe the three-dimensional virtual model from a fixed perspective. In another possible implementation, the model display region may receive a viewing angle change operation of the user, and change a viewing angle of viewing the three-dimensional virtual model according to the viewing angle change operation, so that the user may observe the three-dimensional virtual model in the model display region without dead ends. That is, in response to receiving the viewing angle change operation on the model display region, the client displays an observation image of a default model in the model display region according to an observation angle corresponding to the viewing angle change operation. In another possible implementation, the model display region may be used for displaying a dynamic image of the three-dimensional virtual model, so that the user may observe the three-dimensional virtual model from a plurality of perspectives in the model display region without switching the viewing angle. For example, in the model display region, the three-dimensional virtual model may automatically rotate 360 degrees in situ.

Due to the huge amount of information in the battle settlement interface, and the model display needs to occupy a relatively large space in the interface, the model display region is only used for displaying a virtual character model corresponding to one user account, and may not simultaneously display virtual characters of a plurality of user accounts. In addition, because a technical problem to be resolved by this application improves the efficiency of knowing the battle settlement information from the battle settlement interface by the user, by displaying the virtual character model of the user account currently selected by the user in the model display region, the user may quickly know the battle settlement information corresponding to which virtual character in the game battle currently being viewed by observing the virtual character model.

In an exemplary implementation, the model display region may further display account information of the user account corresponding to the virtual character model being displayed. For example, in step 210, when the model display region is displaying a first model of the first user account, account information of the first user account may further be displayed in the model display region, and the account information includes: at least one of an avatar, a nickname, and a level of the user account, a score in the game battle, and a name of the virtual character controlled in the battle.

For example, the first user account may be a user account selected to be viewed by the user in the last selection operation. The first user account may also be a default user account. For example, the default user account may be the master user account, or a user account of an MVP in the battle. The master user account is a user account currently logged in on the client on the terminal. The user account of the MVP in the battle is a user account of a winning team that obtains an MVP logo. For example, the user account of the MVP may be understood as a user account with the highest score in the winning team.

For example, the first user account and the second user account are both user accounts participating in the game battle. The first user account and the second user account may belong to the same camp (team), or may belong to different camps (team).

The first model includes at least one of a first control character model and a first playing character model, the first control character model is a virtual character controlled by the first user account in the game battle, and the first playing character model is a virtual character played by the first user account.

For example, the virtual character controlled by the user account in the game battle is referred to as a control character, and a game character played by the user account is referred to as a playing character.

In an exemplary implementation, the playing character is a virtual character played by a user account outside the game battle, and the control character is a virtual character (the control character may also be understood as a virtual character controlled by a playing character) that the user account controls in the game battle. In another possible implementation, the playing character may simultaneously appear in the game battle together with the control character, and the user controls the playing character to cause the playing character to control the control character to perform activities in the virtual environment.

A description is made below by using an example in which a playing character is a virtual character played by a user account outside the game battle.

For example, the activities outside the game battle are performed by the playing character by the user. For example, the activities outside the game battle include: at least one of a social activity, a purchase activity, completing tasks, a recharge activity, setting parameters in a game battle, team formation and matching in a game battle, and a preparation activity before a game battle.

For example, the social activity includes at least one of: adding a friend, interacting with a friend, chatting, forming a team with friends, forming a close relationship, joining a team, joining a guild, apprenticeship, watching a battle, transmitting an email, and receiving an email. For example, the purchase activity includes at least one of purchasing a control character, purchasing a skin of a control character, purchasing a prop that takes effect outside the game battle, purchasing a prop that takes effect in the game battle, giving a gift to another control character, drawing a prize, purchasing a privilege, and recharging membership. For example, completing tasks includes: receiving a task, submitting a task, and obtaining a task reward. For example, the recharge activity includes: using currency outside a game and electronic resources exchange/purchasing virtual currency, electronic resources, or the like in a game. Setting parameters in the game battle includes: setting general setting parameters (volume, image quality, or the like) in a game; setting a display layout of a game battle (control position, icon position, control display manner, control usage manner); and presetting at least one of an attribute, a shortcut message, special effects in the game battle, and a skin of each control character in the game battle. For example, team formation and matching in a game battle includes: at least one of entering a team-forming room in the game battle, inviting a friend, inviting a teammate in a team/guild, inviting an unfamiliar playing character in a chat channel, inviting a nearby person and performing matching with teammates in the game battle. For example, the preparation activity before a game battle includes: after matching is completed in the game battle, at least one of selecting a control character to be controlled in the game battle, selecting an additional skill, selecting an attribute bonus of the control character, and loading resources of the game battle, or the like.

For example, the control character is a virtual character controlled by the user in the game battle. The user controls the control character to perform activities in the virtual environment of the game battle to attack an enemy control character and destroy an enemy base to obtain victory of the game. For example, the activities that the user can control the control character to perform in the virtual environment of the game battle include: at least one of moving, using a skill, normal attacking, purchasing equipment, selling equipment, controlling camera movement, upgrading a control character, upgrading a skill, restoring health points of the control character, and teleporting.

For example, outside the game battle, the playing character may be displayed as a three-dimensional virtual character with a three-dimensional virtual model, may also be displayed as a two-dimensional virtual character of a two-dimensional image, or may further be displayed as a 2.5-dimensional virtual character of a 2.5-dimensional image.

In an exemplary implementation, outside the game battle, the playing character may be displayed in a fixed scene. For example, after the client is run, a fixed two-dimensional scene or three-dimensional scene is set in a main user interface just entering the client to display the playing character. For example, the fixed scene refers to that a region range of the scene is very small (for example, a display range on a display screen of the terminal may cover the whole scene or at least half of the scene). In an exemplary implementation, the user may control the playing character to perform activities (moving, jumping, using a prop, playing an action, playing special effects, or the like) in the fixed scene. In another possible implementation, the user cannot control the playing character to move in the fixed scene, that is, a position of the playing character is fixed at a specified position in the fixed scene. In some embodiments, when the playing character is a three-dimensional virtual character, the user may also control the playing character to rotate left or right in situ, so that the user may observe the playing character 360°. In some embodiments, the user may also control the playing character to perform a specified action in situ.

In another possible implementation, there is another virtual environment outside the game battle. To distinguish the virtual environment from the virtual environment in the game battle, the virtual environment outside the game battle is named as the virtual environment outside game battle. For example, a region range of the virtual environment outside the battle is very large, and only a small part of region (one-fifth, one-tenth, or even smaller) of the virtual environment outside the battle may be displayed on the display screen of the terminal. In the virtual environment outside the battle, the user may control the playing character to perform activities (moving, jumping, using a prop, playing an action, play special effects, or the like).

For example, because the virtual environment in the game battle is usually a 2.5-dimensional or three-dimensional virtual environment, the control character is a 2.5-dimensional or three-dimensional virtual character.

For example, a playing character and a control character correspond to the same user account. For example, one user account may correspond to a plurality of playing characters, and one playing character may correspond to a plurality of control characters. For example, one user account creates a plurality of a plurality of playing characters on a plurality of game servers of a game program, or one user account creates a plurality of playing characters on one game server of the game program. For example, the control character is obtained by the playing character outside the game battle, and the user chooses to use the control character to play the game battle at the beginning of the game battle only when the user obtains the control character by using the playing character outside the game battle. For example, a manner of obtaining the control character by the playing character may be at least one of obtaining by purchasing, obtaining by gifting, obtaining by completing a task, obtaining by redeeming, and natively obtaining (a control character that is automatically obtained when a playing character is created). For example, a playing character may have a plurality of control characters. For example, the playing character may obtain virtual currency by completing a task outside the game battle, or obtain virtual currency by playing a game battle, so as to use the virtual currency to purchase a new control character. In this way, the playing character may obtain a plurality of control characters.

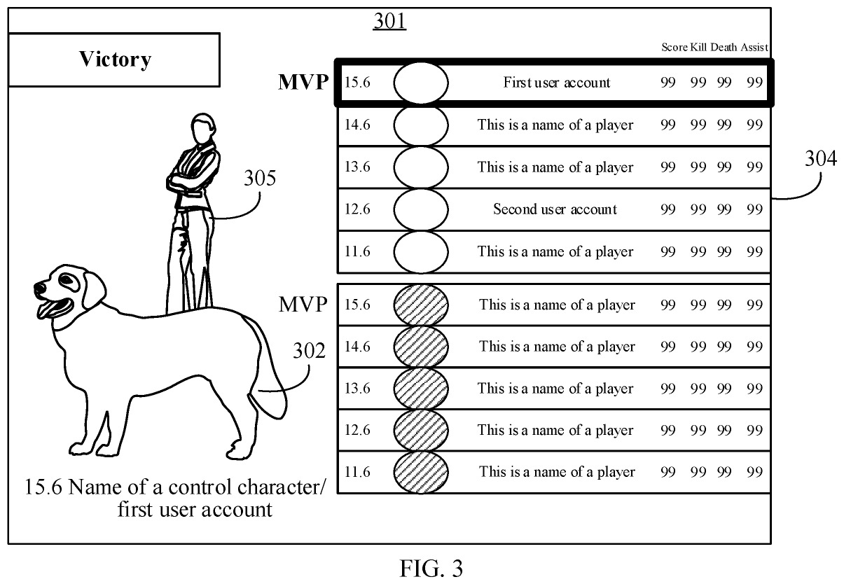

For example, as shown in FIG. 3, a battle settlement interface 301 is provided. The first model of the first user account is displayed in the model display region on the left side of the battle settlement interface 301. For example, the first model includes a control character model 302 and a playing character model 305 of the first user account.

Step 220. Receive a trigger operation of selecting the second user account.

Battle settlement information of each user account participating in the game battle is displayed in the battle settlement interface. The client may receive any form of trigger operation of selecting one of the user accounts. For example, the client may receive a trigger operation on any piece of the battle settlement information of the second user account to determine to select the second user account. Alternatively, the client may receive an operation of swiping left or right, or up or down in the model display region, and determine that the operation selects the second user account according to a preset order.

For example, the trigger operation indicates that the user currently pays attention to the battle settlement information of the second user account. Therefore, after receiving the trigger operation, the client correspondingly displays the second model corresponding to the second user account in the model display region, so that when viewing the battle settlement information of the second user account, the user may intuitively associate the battle settlement information with the three-dimensional virtual character model viewed in the game battle by observing the second model. The virtual character model may be a full-body model. In this way, the efficiency recognizing each user account from the battle settlement information and knowing the battle settlement information of each user account by the user is further improved.

Step 230. Display a second model corresponding to the second user account in the model display region of the battle settlement interface in replacement of the first model corresponding to the first user account, the second model being a virtual character model corresponding to the second user account.

The second user account is a user account selected by the trigger operation. The second user account may be any user account other than the first user account participating in the game battle.

For example, the second model includes at least one of a second control character model and a second playing character model, the second control character model is a virtual character controlled by the second user account in the game battle, and the second playing character model is a virtual character played by the second user account outside the game battle.

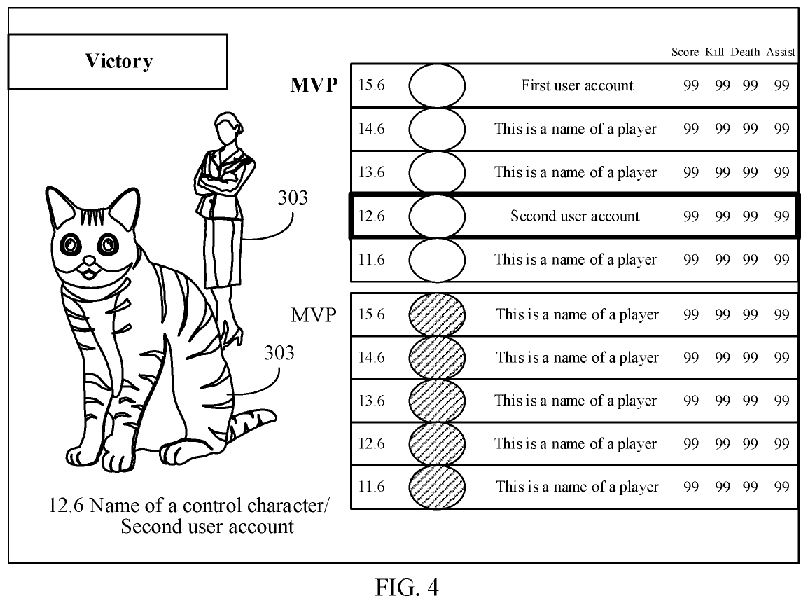

For example, as shown in FIG. 4, when the client receives the trigger operation on the battle settlement information of the second user account, the second model 303 corresponding to the second user account is displayed in the model display region.

In this embodiment provided in this application, the model display region may be used for simultaneously displaying virtual character models of the playing character and the control character of the user account, that is, displaying two virtual character models. The method may integrate intellectual properties (IP) of other famous works into the game program, enhance the sense of IP substitution, and enable an original character (playing character) of the game program to interact with an IP character (control character).

For example, the playing character and the control character may be characters in IP worlds of different works. For example, the playing character is a character in an IP world of a first work, and the control character is a character in an IP world of a second work. For example, the playing character is a character A in a work A, and the control character is a character B in a work B.

In summary, in the method provided in this embodiment of this application, by setting a model display region in a battle settlement interface, the model display region is used for displaying models of user accounts participating in the battle. When the user selects a specific user account to participate in the battle, a virtual character model corresponding to the user account is displayed in the model display region. Because the virtual environment of the game is a three-dimensional virtual environment, what the user usually sees when playing the game is a three-dimensional model of a virtual character. The virtual character model is displayed in the battle settlement interface, so that the user may intuitively associate a currently viewed user account with the virtual character viewed in the virtual environment by observing the virtual character model, thereby improving the information delivering efficiency of directly delivering battle settlement information to the user, balancing the information density of the battle settlement interface, and improving the efficiency of obtaining the battle settlement information by the user.

For example, two operation examples of selecting the second user account are provided, and an example of performing a distinguishable display on information of the second user account in the battle settlement interface after the second user account is selected is further provided.

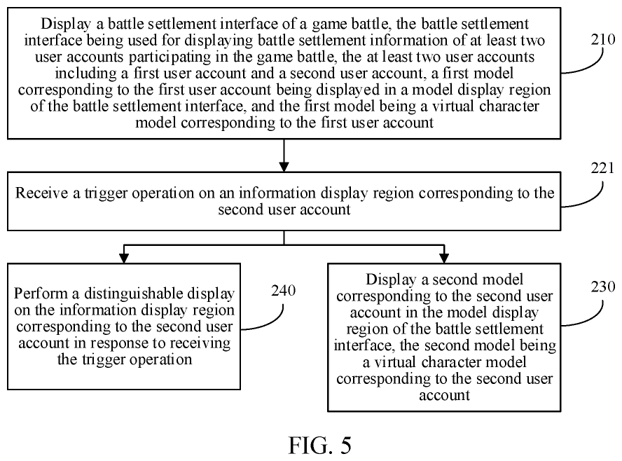

FIG. 5 is a flowchart of a battle settlement interface display method according to an exemplary embodiment of this application. The method may be performed by a client running on any terminal in FIG. 1, and the client is a client supporting a virtual environment. Based on the method shown in FIG. 2, step 220 further includes step 221, and step 240 is further included after step 230.

Step 210. Display a battle settlement interface of a game battle, the battle settlement interface including battle settlement information of at least two user accounts participating in the game battle, the at least two user accounts including a first user account and a second user account, a first model corresponding to the first user account being displayed in a model display region of the battle settlement interface, and the first model being a virtual character model corresponding to the first user account.

In response to that the game battle is over, the client transmits a battle settlement request to the server, where the battle settlement request is used for requesting the server to perform settlement on the current game battle to obtain battle settlement information. In response to receiving battle settlement information transmitted by the server, the client displays the battle settlement interface of the game battle according to the battle settlement information, where the battle settlement information includes model information respectively corresponding to the at least two user accounts participating in the game battle, and the model information is used for displaying the virtual character model corresponding to the user account in the model display region.

For example, the server transmits model information of all user accounts participating in the game battle to the client, and the client writes the model information into a database after receiving the model information. However, when rendering the battle settlement interface for the first time, the client only renders and displays the virtual character model of the default user account in the model display region. When receiving a trigger operation acting on other user accounts in the interface, the client reads the model information of the corresponding user account, and renders and displays the virtual character model corresponding to the user account in the model display region.

Step 221. Receive the trigger operation on the information display region corresponding to the second user account.

For example, the battle settlement interface further displays information display regions respectively corresponding to the at least two user accounts, and the information display region corresponding to the second user account is used for displaying the battle settlement information of the second user account.

In an exemplary implementation, the information display region is a bar-shaped region, various types of battle settlement information of the user account in the game battle are displayed in an arrangement manner in the bar-shaped region. Therefore, the information display region may also be referred to as an information display bar.

For example, as shown in FIG. 3, information bars 304 respectively corresponding to each user account are displayed on the right side of the battle settlement interface 301. The user may click an information bar of the second user account to select the second user account.

In another possible implementation, the battle settlement interface further displays information display regions respectively corresponding to the at least two user accounts, the information display region is used for displaying the battle settlement information, and a display of the information display region in the battle settlement interface has an arrangement order. The client receives a switching operation on the model display region, where the switching operation is used for determining the second user account in combination with the arrangement order.

That is, the model display region of the battle settlement interface may receive a switching operation (for example, swiping left or right, or swiping up or down). The information display region of each user account is arranged in order in the battle settlement interface. According to a direction of the switching operation performed by the user, the user account corresponding to the model currently displayed in the model display region, and the arrangement order of the user account obtained based on the arrangement order of the information display region, the client may then determine a model of which user account should be displayed next after receiving the switching operation. For example, if the first user account and the second user account are arranged in order, and the model of the first user account is currently displayed, then, after receiving a switching operation of swiping to the right, the model of the first user account is switched and displayed as a model of the second user account.

Step 230. Display a second model corresponding to the second user account in the model display region of the battle settlement interface in replacement of the first model corresponding to the first user account, the second model being a virtual character model corresponding to the second user account.

In an exemplary implementation, the user may purchase a costume to dress up a playing character, or purchase a skin to dress up a control character.

The model information corresponding to the second user account further includes dressing information of the second model; and the client displays the second model of the second user account in a second dressing style in the model display region of the battle settlement interface according to the model information corresponding to the second user account, where the second dressing style is determined according to the dressing information.

For example, the dressing information includes at least one of costume information of the playing character and skin information of the control character. The costume information may include at least one of a top, a bottom, a skirt, a suit, a hair accessory, a hat, a hairstyle, a face shape, face features, an expression, shoes, jewelry, a wing, or other decorations of the playing character. The skin information includes an identifier of the skin selected by the second user account to dress up the control character in the game battle. For example, the skin information may also be the same type of information as the costume information. That is, the user may purchase corresponding clothing for the control character to dress up.

Step 240. Perform a distinguishable display on the information display region corresponding to the second user account in response to receiving the trigger operation.

When receiving the trigger operation for selecting the second user account, the client further performs a distinguishable display on the information display region corresponding to the second user account in the battle settlement interface, so as to prompt the user account to view the battle settlement information of the second user account, so that the user intuitively associates the battle settlement information of the second user account with the virtual character model of the second user account, thereby improving the efficiency of viewing the battle settlement information by the user.

The distinguishable display includes at least one of highlighting the information display region, changing color of the information display region, displaying text in the information display region in bold, and displaying a check box in the information display region.

For example, a highlighted selection circle is displayed on the periphery of the information display region of the second user account, thereby clearly distinguishing the information display region of the second user account from information display regions of other user accounts. Alternatively, the information display region of the second user account is colored with a color that is different from the information display regions of other user accounts; or at least one of bolding, inclining, or adding underline is performed on the text in the information display region of the second user account.

In an exemplary implementation, the information display region is used for displaying the battle settlement information of the user account in the form of text or numbers. For example, the text includes a nickname of the user account, and the numbers include a score and KDA. When the client receives the trigger operation of selecting the second user account, the client may further display the detailed battle settlement information of the second user account in the battle settlement interface.

For example, the client displays chart battle settlement information of the second user account in response to receiving the trigger operation, where the chart battle settlement information includes at least one type of chart information. That is, the client more intuitively displays the battle settlement information of the second user account to the user in the form of a chart. Chart information includes an economic trend chart, a scoring trend chart, a pie chart, or a radar chart generated according to data of a plurality of indicators of the user account in the game battle.

For example, the chart information may be displayed in the battle settlement interface, or on an upper layer of the battle settlement interface, for example, displayed on the upper layer of the battle settlement interface in the form of a small window.

In summary, in the method provided in this embodiment, the information display region of each user account is displayed in the battle settlement interface. The trigger operation that the second user account is selected by the user may be a trigger operation in the information display region of the second user account. The trigger operation indicates that the user pays attention to the battle settlement information of the second user account. Therefore, according to the trigger operation, the virtual character model of the second user account is displayed in the model display region, so that the user may directly link the battle settlement information with the virtual character model in the game battle, thereby improving the efficiency of reading the battle settlement information by the user.

In the method provided in this embodiment, when the virtual character model of the second user account is displayed according to the trigger operation, a distinguishable display is performed on the information display region of the second user account, to prompt the user that the virtual character model displayed in the current model display region corresponds to the battle settlement information, so that it is convenient for the user to identify the user account corresponding to the battle settlement information, thereby improving the reading efficiency of the user.

In an exemplary implementation, after the battle is over, the battle performance display interface of the master user account is further displayed before the battle settlement interface.

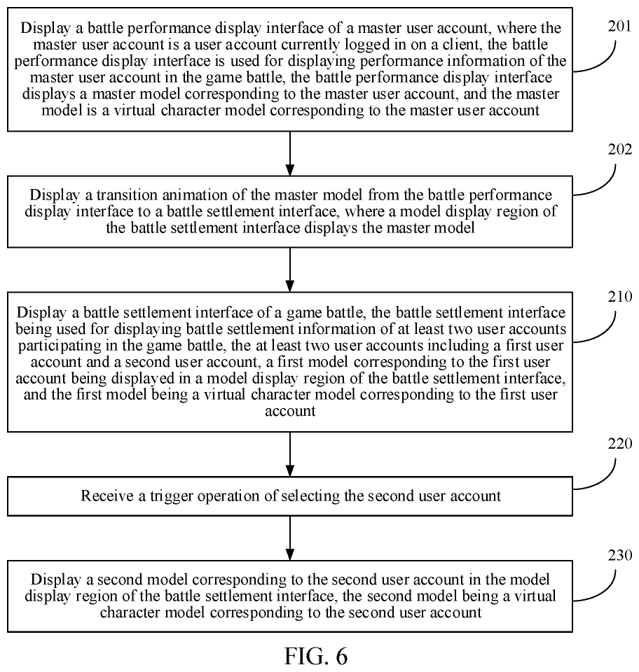

FIG. 6 is a flowchart of a battle settlement interface display method according to an exemplary embodiment of this application. The method may be performed by any terminal in FIG. 1. Specifically, the method may be performed by a client running on the terminal, and the client is a client supporting a virtual environment. Based on the exemplary embodiment shown in FIG. 2, step 201 and step 202 are further included before step 210.

Step 201. Display a battle performance display interface of a master user account, where the master user account is a user account currently logged in on a client, the battle performance display interface is used for displaying performance information of the master user account in the game battle, the battle performance display interface displays a master model corresponding to the master user account, and the master model is a virtual character model corresponding to the master user account.

The battle performance display interface is used for displaying performance information of the master user account in the game battle. For example, the performance information may be the same information as the battle settlement information. For example, the performance information may further be more than the battle settlement information or less than the battle settlement information. In an exemplary implementation, because the battle settlement interface needs to display battle settlement information of a plurality of user accounts, the display of the battle settlement information is usually mainly in the form of text or numbers. In the battle performance display interface, only the battle settlement information of one user account of the master user account needs to be displayed. Therefore, a plurality of forms may be used for presenting the battle settlement information of the master user account in the game battle. For example, the battle settlement information may be displayed in the form of a chart or an animation, and the battle settlement information displayed in a plurality of forms is the performance information.

For example, a master model of the master user account is displayed in the battle performance display interface.

Step 202. Display a transition animation of the master model from the battle performance display interface to the battle settlement interface, where the model display region of the battle settlement interface displays the master model.

For example, the first user account includes the master user account, and the first model includes the master model. That is, the battle settlement interface displays the master model of the master user account by default. Therefore, to better perform a transition between the battle performance display interface and the battle settlement interface, a transition animation for moving the master model from the battle performance display interface to the battle settlement interface is displayed.

For example, the transition animation may be to control the master model to perform a jumping action, and to simultaneously perform a switching display on two interfaces. Alternatively, the transition animation may be to control the master model from a position in the battle performance display interface to a position in the battle settlement interface, and simultaneously perform a switching display on the two interfaces

In summary, in the method provided in this embodiment, the model displayed by default in the battle settlement performance interface is set as the master model of the master user account. The transition animation is used, so that the transition of switching from the battle performance display interface to the battle settlement interface is better connected, and the fluency of interface switching is improved.

For example, an exemplary embodiment is provided in which the client and the server implement the battle settlement interface display method provided in this application.

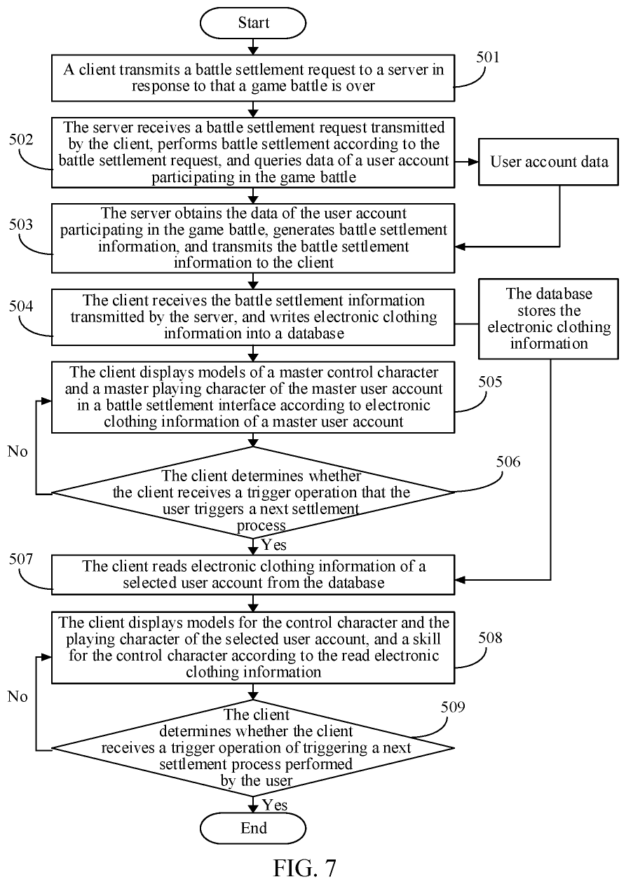

FIG. 7 is a flowchart of a battle settlement interface display method according to an exemplary embodiment of this application. The method may be performed by the computer system in FIG. 1. The method includes the following steps.

Step 501. The client transmits a battle settlement request to a server in response to that the game battle is over.

Step 502. The server receives a battle settlement request transmitted by the client, performs battle settlement according to the battle settlement request, and queries data of the user account participating in the game battle.

Step 503. The server obtains the data of the user account participating in the game battle, generates battle settlement information, and transmits the battle settlement information to the client. The battle settlement information includes electronic clothing information of the playing character (for example, trainer) and the control character (for example, trained pet) of the user account participating in the game battle.

Step 504. The client receives the battle settlement information transmitted by the server, and writes the electronic clothing information into the database.

Step 505. The client displays models of a master control character and a master playing character of the master user account in the battle settlement interface according to the electronic clothing information of the master user account, and the model presents the dressing style indicated in the electronic clothing information.

Step 506. The client determines whether the client receives an operation of clicking to view other user accounts performed by the user, and if yes, performs step 507, otherwise returns to step 505.

Step 507. The client reads the electronic clothing information of the selected user account from the database.

Step 508. The client displays models for the control character and the playing character of the selected user account, and a skill for the control character according to the read electronic clothing information.

Step 509. The client determines whether the client receives a trigger operation of triggering a next settlement process performed by the user, and if yes, ends a display process of the battle settlement interface; and otherwise, returns to step 508.

Apparatus embodiments of this application are described below. Reference may be made to the foregoing method embodiments for details that are not described in the apparatus embodiments.

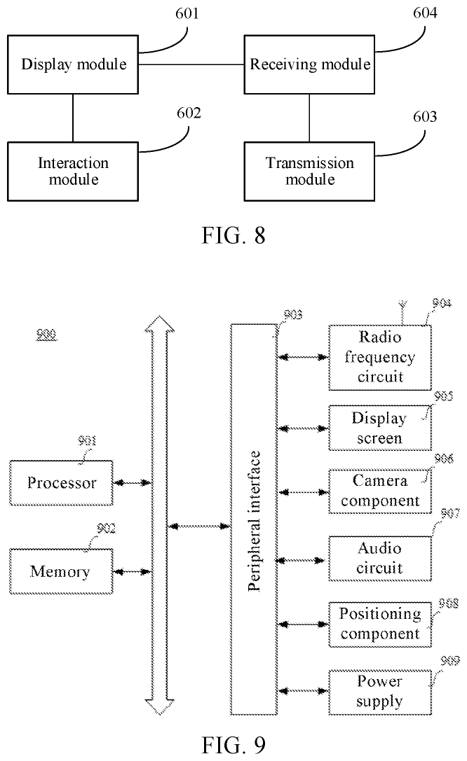

FIG. 8 is a block diagram of a battle settlement interface display apparatus according to an exemplary embodiment of this application. The apparatus includes:

a display module 601, configured to display a battle settlement interface of a game battle, the battle settlement interface including battle settlement information of at least two user accounts participating in the game battle, the at least two user accounts including a first user account and a second user account, a first model corresponding to the first user account being displayed in a model display region of the battle settlement interface, and the first model being a virtual character model corresponding to the first user account;

an interaction module 602, configured to receive a trigger operation of selecting the second user account; and

the display module 601 is further configured to display a second model corresponding to the second user account in the model display region of the battle settlement interface in replacement of the first model corresponding to the first user account, the second model being a virtual character model corresponding to the second user account.

In an exemplary embodiment, the battle settlement interface further displays information display regions respectively corresponding to the at least two user accounts, and the information display region corresponding to the second user account is used for displaying the battle settlement information of the second user account. The apparatus further includes:

an interaction module 602, configured to receive the trigger operation on the information display region corresponding to the second user account.

In an exemplary embodiment, the display module 601 is further configured to perform a distinguishable display on the information display region corresponding to the second user account in response to receiving the trigger operation.

The distinguishable display includes at least one of highlighting the information display region, changing color of the information display region, displaying text in the information display region in bold, and displaying a check box in the information display region.

In an exemplary embodiment, the display module 601 is further configured to display chart battle settlement information of the second user account in response to receiving the trigger operation, where the chart battle settlement information includes at least one type of chart information.

In an exemplary embodiment, the battle settlement interface further displays information display regions respectively corresponding to the at least two user accounts, the information display region is used for displaying the battle settlement information, and a display of the information display region in the battle settlement interface has an arrangement order.

The interaction module 602 is further configured to receive a switching operation on the model display region, where the switching operation is used for determining the second user account in combination with the arrangement order.

In an exemplary embodiment, the first model includes at least one of a first control character model and a first playing character model, the first control character model is a virtual character controlled by the first user account in the game battle, and the first playing character model is a virtual character played by the first user account; and

the second model includes at least one of a second control character model and a second playing character model, the second control character model is a virtual character controlled by the second user account in the game battle, and the second playing character model is a virtual character played by the second user account outside the game battle.

In an exemplary embodiment, the display module 601 is further configured to display a battle performance display interface of a master user account, where the master user account is a user account currently logged in on a client, the battle performance display interface is used for displaying performance information of the master user account in the game battle, the battle performance display interface displays a master model corresponding to the master user account, and the master model is a virtual character model corresponding to the master user account.

In an exemplary embodiment, the first user account includes the master user account, and the first model includes the master model; and

the display module 601 is further configured to display a transition animation of the master model from the battle performance display interface to the battle settlement interface, where the model display region of the battle settlement interface displays the master model.

In an exemplary embodiment, the apparatus further includes:

a transmission module 603, configured to transmit a battle settlement request to a server in response to that the game battle is over;

a receiving module 604, configured to receive battle settlement information transmitted by a server;

the display module 601 is further configured to display, in response to receiving battle settlement information transmitted by the server, the battle settlement interface of the game battle according to the battle settlement information, where the battle settlement information includes model information respectively corresponding to the at least two user accounts participating in the game battle; and

the display module 601 is further configured to display the second model corresponding to the second user account in the model display region of the battle settlement interface according to the model information corresponding to the second user account.

In an exemplary embodiment, the model information corresponding to the second user account further includes dressing information of the second model; and

the display module 601 is further configured to display the second model in a second dressing style in the model display region of the battle settlement interface according to the model information corresponding to the second user account, where the second dressing style is determined according to the dressing information.

The battle settlement interface display apparatus provided in the foregoing embodiments is illustrated with an example of division of the foregoing functional modules. In actual application, the foregoing functions may be assigned to and completed by different function modules as required. That is, an internal structure of the device may be divided into different function modules to complete all or some of the functions described above. In addition, the battle settlement interface display apparatus and the battle settlement interface display method embodiments provided in the foregoing embodiments belong to one conception. For the specific implementation process, refer to the method embodiments, and details are not described herein again.

This application further provides a terminal. The terminal includes a processor and a memory, the memory stores at least one computer-readable instruction, and the at least one computer-readable instruction is loaded and executed by the processor to implement the battle settlement interface display method provided in the foregoing method embodiments. The server may be a terminal provided in the terminal in FIG. 9 below.

FIG. 9 is a structural block diagram of a terminal 900 according to an exemplary embodiment of this application. The terminal 900 may be a smartphone, a tablet computer, a Moving Picture Experts Group Audio Layer III (MP3) player, a Moving Picture Experts Group Audio Layer IV (MP4) player, a notebook computer, or a desktop computer. The terminal 900 may also be referred to as user equipment, a portable terminal, a laptop terminal, a desktop terminal, or by another name.

Generally, the terminal 900 includes a processor 901 and a memory 902.

The processor 901 may include one or more processing cores, for example, a 4-core processor or an 8-core processor. The processor 901 may be implemented by using at least one hardware form of a digital signal processor (DSP), a field-programmable gate array (FPGA), and a programmable logic array (PLA). The processor 901 may also include a main processor and a coprocessor. The main processor is a processor configured to process data in an awake state, and is also referred to as a central processing unit (CPU). The coprocessor is a low power consumption processor configured to process the data in a standby state. In some embodiments, a graphics processing unit (GPU) may be integrated into the processor 901. The GPU is configured to be responsible for rendering and drawing content to be displayed on a display screen. In some embodiments, the processor 901 may further include an artificial intelligence (AI) processor. The AI processor is configured to process computing operations related to machine learning.

The memory 902 may include one or more computer-readable storage media that may be non-transitory. The memory 902 may further include a high-speed random access memory and a non-transitory memory, such as one or more magnetic disk storage devices or flash storage devices. In some embodiments, the non-transient computer-readable storage medium in the memory 902 is configured to store at least one computer-readable instruction, and the at least one computer-readable instruction is configured to be executed by the processor 901 to perform the battle settlement interface display method provided in the method embodiments of this application.

In some embodiments, the terminal 900 may optionally include: a peripheral device interface 903 and at least one peripheral device. The processor 901, the memory 902, and the peripheral interface 903 may be connected by using a bus or a signal cable. Each peripheral may be connected to the peripheral interface 903 through a bus, a signal cable, or a circuit board. Specifically, the peripheral includes: at least one of a radio frequency (RF) circuit 904, a display screen 905, a camera component 906, an audio frequency circuit 907, a positioning component 908, and a power source 909.

A person skilled in the art may understand that the structure shown in FIG. 9 does not constitute a limitation to the terminal 900, and the terminal may include more or fewer components than those shown in the figure, or some components may be combined, or a different component deployment may be used.

The memory further includes one or more programs. The one or more programs are stored in the memory and include the battle settlement interface display method provided in the embodiments of this application.

This application provides a computer-readable storage medium, the storage medium storing at least one computer-readable instruction, and the at least one computer-readable instruction being loaded and executed by a processor to implement the battle settlement interface display method according to the foregoing method embodiments.

This application further provides a computer program product or a computer program, the computer program product or the computer program including computer instructions, the computer instructions being stored in a computer-readable storage medium. A processor of a computer device reads the computer-readable instructions from the computer-readable storage medium and executes the computer-readable instructions to cause the computer device to perform the battle settlement interface display method provided in the foregoing optional implementations.

The sequence numbers of the foregoing embodiments of this application are merely for description purpose, and are not intended to indicate the preference among the embodiments.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely embodiments of this application, but are not intended to limit this application. Any modification, equivalent replacement, or improvement made within the spirit and principle of this application shall fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A battle settlement interface display method, performed by a computer device, the method comprising:
displaying a battle settlement interface of a game battle, the battle settlement interface including battle settlement information of at least two user accounts participating in the game battle, the at least two user accounts comprising a first user account and a second user account, a first model corresponding to the first user account being displayed in a model display region of the battle settlement interface, and the first model being a virtual character model corresponding to the first user account;
receiving a trigger operation of selecting the second user account; and
displaying a second model corresponding to the second user account in the model display region of the battle settlement interface in replacement of the first model corresponding to the first user account, the second model being a virtual character model corresponding to the second user account.

2. The method according to claim 1, wherein the battle settlement interface further includes information display regions respectively corresponding to the at least two user accounts, and the information display region corresponding to the second user account is used for displaying the battle settlement information of the second user account; and
the receiving a trigger operation of selecting the second user account comprises:
receiving the trigger operation on the information display region corresponding to the second user account.

3. The method according to claim 2, further comprising:
performing a distinguishable display on the information display region corresponding to the second user account in response to receiving the trigger operation, wherein
the distinguishable display comprises at least one of highlighting the information display region, changing color of the information display region, displaying text in the information display region in bold, and displaying a check box in the information display region.

4. The method according to claim 1, further comprising:
displaying chart battle settlement information of the second user account in response to receiving the trigger operation, wherein the chart battle settlement information comprises at least one type of chart information.

5. The method according to claim 1, wherein the battle settlement interface further includes information display regions respectively corresponding to the at least two user accounts, each information display region is used for displaying the battle settlement information of a corresponding user account, and a display of the information display region in the battle settlement interface has an arrangement order; and
the receiving a trigger operation of selecting the second user account comprises:
receiving a switching operation on the model display region, wherein the switching operation is used for determining the second user account in combination with the arrangement order.

6. The method according to claim 1, wherein the first model comprises at least one of a first control character model and a first playing character model, the first control character model is a virtual character controlled by the first user account in the game battle, and the first playing character model is a virtual character played by the first user account; and
the second model comprises at least one of a second control character model and a second playing character model, the second control character model is a virtual character controlled by the second user account in the game battle, and the second playing character model is a virtual character played by the second user account outside the game battle.

7. The method according to claim 1, wherein before the displaying a battle settlement interface of a game battle, the method further comprises:
displaying a battle performance display interface of a master user account, wherein the master user account is a user account currently logged in on a client, the battle performance display interface including performance information of the master user account in the game battle and a master model corresponding to the master user account, and the master model is a virtual character model corresponding to the master user account.

8. A computer device, comprising one or more processors and memories, the one or more memories storing computer-readable instructions, the computer-readable instructions, when executed by the one or more processors, causing the computer device to implement a battle settlement interface display method including:
displaying a battle settlement interface of a game battle, the battle settlement interface including battle settlement information of at least two user accounts participating in the game battle, the at least two user accounts comprising a first user account and a second user account, a first model corresponding to the first user account being displayed in a model display region of the battle settlement interface, and the first model being a virtual character model corresponding to the first user account;
receiving a trigger operation of selecting the second user account; and
displaying a second model corresponding to the second user account in the model display region of the battle settlement interface in replacement of the first model corresponding to the first user account, the second model being a virtual character model corresponding to the second user account.

9. The computer device according to claim 8, wherein the battle settlement interface further includes information display regions respectively corresponding to the at least two user accounts, and the information display region corresponding to the second user account is used for displaying the battle settlement information of the second user account; and
the receiving a trigger operation of selecting the second user account comprises:
receiving the trigger operation on the information display region corresponding to the second user account.

10. The computer device according to claim 9, wherein the method further comprises:
performing a distinguishable display on the information display region corresponding to the second user account in response to receiving the trigger operation, wherein
the distinguishable display comprises at least one of highlighting the information display region, changing color of the information display region, displaying text in the information display region in bold, and displaying a check box in the information display region.

11. The computer device according to claim 8, wherein the method further comprises:
displaying chart battle settlement information of the second user account in response to receiving the trigger operation, wherein the chart battle settlement information comprises at least one type of chart information.

12. The computer device according to claim 8, wherein the battle settlement interface further includes information display regions respectively corresponding to the at least two user accounts, each information display region is used for displaying the battle settlement information of a corresponding user account, and a display of the information display region in the battle settlement interface has an arrangement order; and
the receiving a trigger operation of selecting the second user account comprises:
receiving a switching operation on the model display region, wherein the switching operation is used for determining the second user account in combination with the arrangement order.

13. The computer device according to claim 8, wherein the first model comprises at least one of a first control character model and a first playing character model, the first control character model is a virtual character controlled by the first user account in the game battle, and the first playing character model is a virtual character played by the first user account; and
the second model comprises at least one of a second control character model and a second playing character model, the second control character model is a virtual character controlled by the second user account in the game battle, and the second playing character model is a virtual character played by the second user account outside the game battle.

14. The computer device according to claim 8, wherein before the displaying a battle settlement interface of a game battle, the method further comprises:
displaying a battle performance display interface of a master user account, wherein the master user account is a user account currently logged in on a client, the battle performance display interface including performance information of the master user account in the game battle and a master model corresponding to the master user account, and the master model is a virtual character model corresponding to the master user account.

15. One or more non-transitory computer-readable storage media storing computer-readable instructions, the non-transitory computer-readable storage media storing the computer-readable instructions, the computer-readable instructions, when executed by one or more processors of a computer device, causing the computer device to implement a battle settlement interface display method including:
displaying a battle settlement interface of a game battle, the battle settlement interface including battle settlement information of at least two user accounts participating in the game battle, the at least two user accounts comprising a first user account and a second user account, a first model corresponding to the first user account being displayed in a model display region of the battle settlement interface, and the first model being a virtual character model corresponding to the first user account;
receiving a trigger operation of selecting the second user account; and
displaying a second model corresponding to the second user account in the model display region of the battle settlement interface in replacement of the first model corresponding to the first user account, the second model being a virtual character model corresponding to the second user account.

16. The non-transitory computer-readable storage media according to claim 15, wherein the battle settlement interface further includes information display regions respectively corresponding to the at least two user accounts, and the information display region corresponding to the second user account is used for displaying the battle settlement information of the second user account; and
the receiving a trigger operation of selecting the second user account comprises:
receiving the trigger operation on the information display region corresponding to the second user account.

17. The non-transitory computer-readable storage media according to claim 15, wherein the method further comprises:
displaying chart battle settlement information of the second user account in response to receiving the trigger operation, wherein the chart battle settlement information comprises at least one type of chart information.

18. The non-transitory computer-readable storage media according to claim 15, wherein the battle settlement interface further includes information display regions respectively corresponding to the at least two user accounts, each information display region is used for displaying the battle settlement information of a corresponding user account, and a display of the information display region in the battle settlement interface has an arrangement order; and
the receiving a trigger operation of selecting the second user account comprises:
receiving a switching operation on the model display region, wherein the switching operation is used for determining the second user account in combination with the arrangement order.

19. The non-transitory computer-readable storage media according to claim 15, wherein the first model comprises at least one of a first control character model and a first playing character model, the first control character model is a virtual character controlled by the first user account in the game battle, and the first playing character model is a virtual character played by the first user account; and
the second model comprises at least one of a second control character model and a second playing character model, the second control character model is a virtual character controlled by the second user account in the game battle, and the second playing character model is a virtual character played by the second user account outside the game battle.

20. The non-transitory computer-readable storage media according to claim 15, wherein before the displaying a battle settlement interface of a game battle, the method further comprises:
displaying a battle performance display interface of a master user account, wherein the master user account is a user account currently logged in on a client, the battle performance display interface including performance information of the master user account in the game battle and a master model corresponding to the master user account, and the master model is a virtual character model corresponding to the master user account.
